(19) United States
(12) Patent Application Publication
(10) Pub. No.: US 2007/0038373 A1
(43) Pub. Date: Feb. 15, 2007

(54) Navigating apparatus with GPS and TMC and method thereof

(75) Inventor: Chun-Yen Chen, Taoyuan City (TW)

Correspondence Address: BACON & THOMAS, PLLC, 625 SLATERS LANE, FOURTH FLOOR, ALEXANDRIA, VA, 22314, US

(73) Assignee: RoyalTek Company Ltd., Taoyuan City (TW)

(21) Appl. No.: 11/484,663

(22) Filed: Jul. 12, 2006

(30) Foreign Application Priority Data
Aug. 12, 2005 (DE) 102005038300.9

(51) Int. Cl. G01C 21/00

(52) U.S. Cl. 701/213; 701/117; 701/200

(57) ABSTRACT

A navigating apparatus with a GPS receiver module and a TMC receiver module, and method thereof are disclosed. The apparatus includes a traffic message channel (TMC) receiver module and a global positioning system (GPS) receiver module connected by an I2C (Inter-IC) interface or any other serial/parallel transmission interfaces. Furthermore, the method includes the steps of a) receiving traffic messages via the TMC receiver module; b) receiving GPS measurements via the GPS receiver module; c) transmitting the traffic messages from the TMC receiver module to the GPS receiver module via the I2C interface; d) transforming the traffic messages and the GPS measurements into navigating messages; and e) transmitting the navigating messages to a remote client for displaying directly.

### FIELD OF THE INVENTION

This invention relates to a portable navigating apparatus and a method thereof, and more particularly to a portable navigating apparatus with integrated global positioning system (GPS) and traffic message channel (TMC) and a method thereof.

### BACKGROUND OF THE INVENTION

Global Positioning System (GPS) can define the position of a user by means of receiving the signal from satellites in space and measuring the distances between the user and satellites. No matter whether the user is situated at land, on sea or in air, all related positions of the user on a map could be measured accurately via GPS. The application of GPS is more and more popular, and then GPS and mobile communication tend to be integrated together ininevitably. If a GPS electronic navigating system is installed into a vehicle, the driver could acquire the related position of himself on the map instead of being mired in problems of losing his way. On the other hand, the position-tracing function of GPS is readily combined and applied with electronic portable apparatus. Therefore, there are a lot of products, such as PDAs and notebook computers, actively tended to work out and integrated with GPS navigating function.

Please refer to FIG. 1. It illustrates a portable computer according to the prior art. The portable computer 1 includes an user interface 11, a CUP 12, at least a memory unit 13, a single connection unit 14, and plural hardware interfaces 21, 22, and 23. Meanwhile, the CPU 12 is connected to the single connection unit 14, and the single connection unit 14 is further connected with a connection device 20, which is controlled by an arithmetic and logic unit 24. The plural hardware interfaces 21 and 22 are respectively connected to a digital position receiving unit 25 and a traffic information receiving unit 26 for receiving related information. According to the structure thereof, the portable computer 1 could deal with the position information and the traffic information. Meanwhile, the position information and the traffic information are respectively transmitted into the portable computer 1 via serial data streams of the digital position receiving unit 25 and the traffic information receiving unit 26. Moreover, that information would be decoded by a decoding program in the memory unit 13, and then the decoded information could be utilized in coordination with mapping information of the program.

However, in practice, the global positioning system and the traffic message channel might be combined into a portable computer, wherein the signal of GPS is merely combined with the signal of TMC into one combined signal, but the combined signal is not integrated effectively and has to be further decoded for utilization. Therefore, it needs to provide a navigating apparatus with GPS and TMC, and method thereof, which is capable of effectively integrating signals of GPS and TMC via a simplified structure, fewer operations and producing steps, and can improve those drawbacks of the prior art and solve the above problems. The present invention discloses a navigating apparatus with GPS and TMC, and method thereof, wherein the signals of GPS and TMC are integrated effectively and the integrating process is achieved via a simplified structure, fewer operations and producing steps, thereby being novel and practical.

### SUMMARY OF THE INVENTION

It is an object of the present invention to provide a navigating apparatus with GPS and TMC, which is capable of effectively integrating signals of GPS and TMC via a simplified structure, fewer operations and producing steps.

In accordance with an aspect of the present invention, the integrated navigating apparatus includes a traffic message channel (TMC) receiver module for receiving traffic messages; a global positioning system (GPS) receiver module for receiving GPS measurements via the GPS receiver module, wherein the GPS receiver module further includes a central processing unit (CPU); a connecting interface connected between the TMC receiver module and the GPS receiver module to transmit the traffic messages from the TMC receiver module to the CPU of the GPS receiver module for integrating the traffic messages and the GPS measurements via the CPU and producing navigating messages; and a local wireless transmitting module connected with the GPS receiver module for transmitting the navigating messages to a remote wireless client, thereby the navigating messages being displayed on the remote wireless client directly.

Preferably, the GPS receiver module further includes a radio frequency (RF) receiving unit and a digital signal processor (DSP) unit.

Preferably, the GPS receiver module further includes a memory unit.

Certainly, the memory unit can be one of RAM memory and FLASH memory.

Certainly, the connecting interface can be an Inter-IC (I2C) interface.

Certainly, the remote wireless client is a Bluetooth transmitting module of a personal digital assistant (PDA).

Preferably, the integrated navigating apparatus further includes a serial port interface connected with the local wireless transmitting module and the GPS receiver module.

In accordance with another aspect of the present invention, the present invention further provides a portable computer with integrated navigating apparatus including a traffic message channel (TMC) receiver module for receiving traffic messages; a global positioning system (GPS) receiver module for receiving GPS measurements via the GPS receiver module, wherein the GPS receiver module further comprises a central processing unit (CPU); a connecting interface connected between the TMC receiver module and the GPS receiver module to transmit the traffic message from the TMC receiver module to the CPU of the GPS receiver module for integrating the traffic messages and the GPS measurements via the CPU and producing navigating messages; a personal digital assistant (PDA) module; and a serial port interface connected with the PDA module and the GPS receiver module for transmitting the navigating messages from the GPS receiver module to the PDA module, thereby the navigating messages being displayed on the PDA module directly.

Preferably, the GPS receiver module further includes a radio frequency (RF) receiving unit and a digital signal processor (DSP) unit.

Preferably, the GPS receiver module further includes a memory unit.

Certainly, the memory unit can be one of RAM memory and FLASH memory.

Certainly, the connecting interface can be an Inter-IC (I2C) interface.

Preferably, the PDA module further includes a CPU, a RAM memory, a FLASH memory, a LCD unit, and a serial port.

It is another object of the present invention to provide a method of integrating navigating-information of a traffic message (TMC) receiver module and a global position system (GPS) receiver module, which is capable of effectively integrating signals of GPS and TMC via a simplified structure, fewer operations and producing steps.

In accordance with an aspect of the present invention, the method of integrating navigating-information of a traffic message channel (TMC) receiver module and a global position system (GPS) receiver module includes the steps of a) receiving traffic messages via the TMC receiver module; b) receiving GPS measurements via the GPS receiver module; c) transmitting the traffic messages from the TMC receiver module to the GPS receiver module; d) transforming the traffic messages and the GPS measurements into navigating messages; and e) transmitting the navigating messages to a remote client for displaying the navigating messages on the remote client directly.

Certainly, the step c) can be executed via an Inter-IC (I2C) interface connected between the TMC receiver module and the GPS receiver module to transmit the traffic messages from the TMC receiver module to the GPS receiver module.

Preferably, the GPS receiver module further includes a CPU.

Certainly, the step e) can be a bluetooth transmission.

Certainly, the step e) can be executed by means of serial-port-interface transmission.

Certainly, the remote client can be a personal digital assistant (PDA) module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates a portable computer with a navigating function according to the prior art;

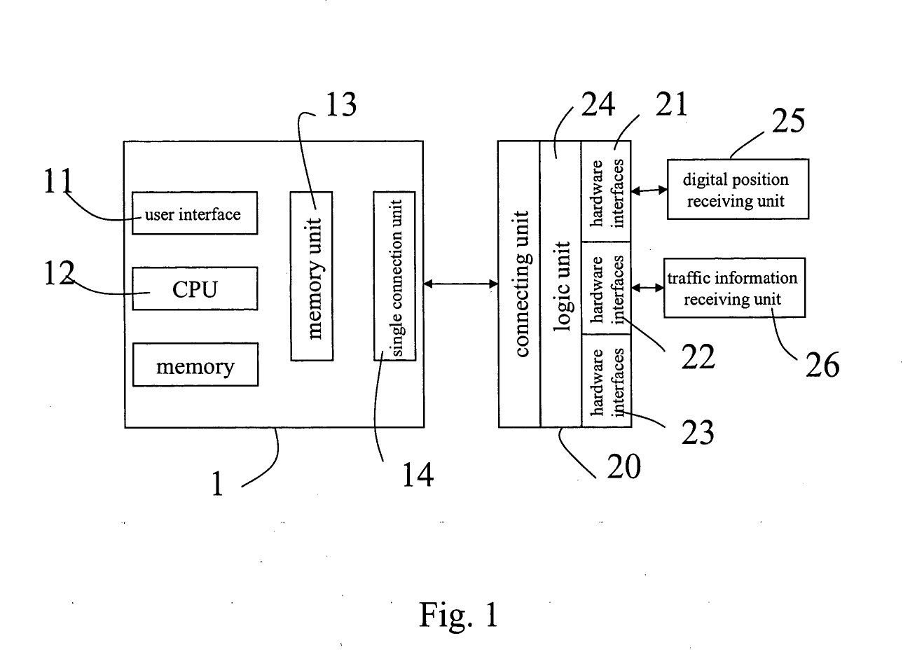

FIG. 2 illustrates a block diagram of a first embodiment of a navigating apparatus with GPS receiver module and TMC receiver module according to the present invention; and

FIG. 3 illustrates a block diagram of a second embodiment of a navigating apparatus with a GPS receiver module and a TMC receiver module according to the present invention.

### DETAILED DESCRIPTION OF THE PREFERRED EMBODIMENT

The present invention discloses a portable navigating apparatus with an integrated global positioning system (GPS) receiver module and a traffic message channel (TMC) receiver module and a method thereof, and the objects and advantages of the present invention will become more readily apparent to those ordinarily skilled in the art after reviewing the following detailed description. The present invention needs not be limited to the following embodiments.

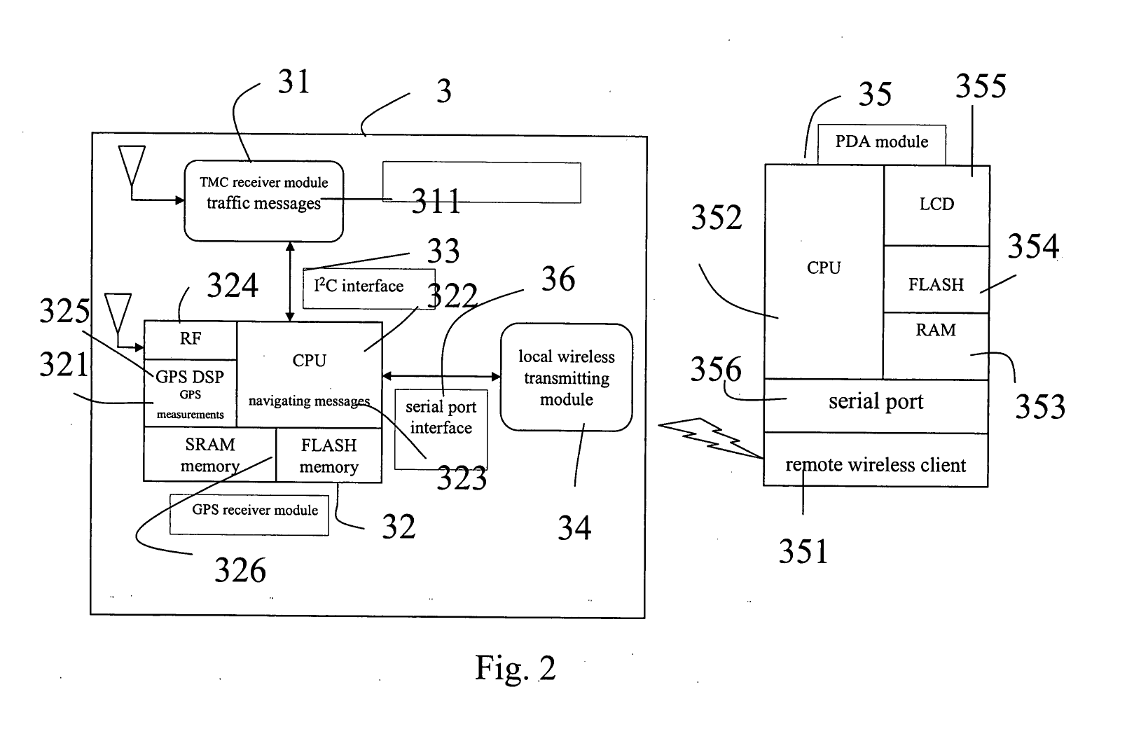

Please refer to FIG. 2. It illustrates a block diagram of a first embodiment of a navigating apparatus with a GPS receiver module and a TMC receiver module according to the present invention. In accordance with an aspect of the present invention, the integrated navigating apparatus 3 includes a traffic message channel (TMC) receiver module 31 for receiving traffic messages 311; a global positioning system (GPS) receiver module 32 for receiving GPS measurements 321 via the GPS receiver module 32, wherein the GPS receiver module 32 further includes a central processing unit (CPU) 322; a connecting interface 33 connected between the TMC receiver module 31 and the GPS receiver module 32 to transmit the traffic message 311 from the TMC receiver module 31 to the CPU 322 of the GPS receiver module 32 for integrating the traffic message 311 and the GPS measurements 321 via the CPU 322 and producing navigating messages 323; and a local wireless transmitting module 34 connected with the GPS receiver module 32 for transmitting the navigating messages 323 to a remote wireless client 351, thereby the navigating messages being displayed on the remote wireless client 351 directly.

In practice, the GPS receiver module 32 further includes a radio frequency (RF) receiving unit 324 and a digital signal processor (DSP) unit325. Certainly, the GPS receiver module 32 further includes a memory unit 326, wherein the memory unit 326 can be comprised of RAM memory and FLASH memory. The present invention further introduces an Inter-IC (I2C) interface or any other serial/parallel transmission interface as the connecting interface 33, which is connected between the TMC receiver module 31 and the GPS receiver module 32 for presenting distinguishing features. Accordingly, the integrated navigating apparatus 3 further includes a serial port interface 36 connected with the local wireless transmitting module 34 and the GPS receiver module 32. Moreover, in the embodiment, the remote wireless client 351 is a Bluetooth transmitting module 351 of a personal digital assistant (PDA) 35.

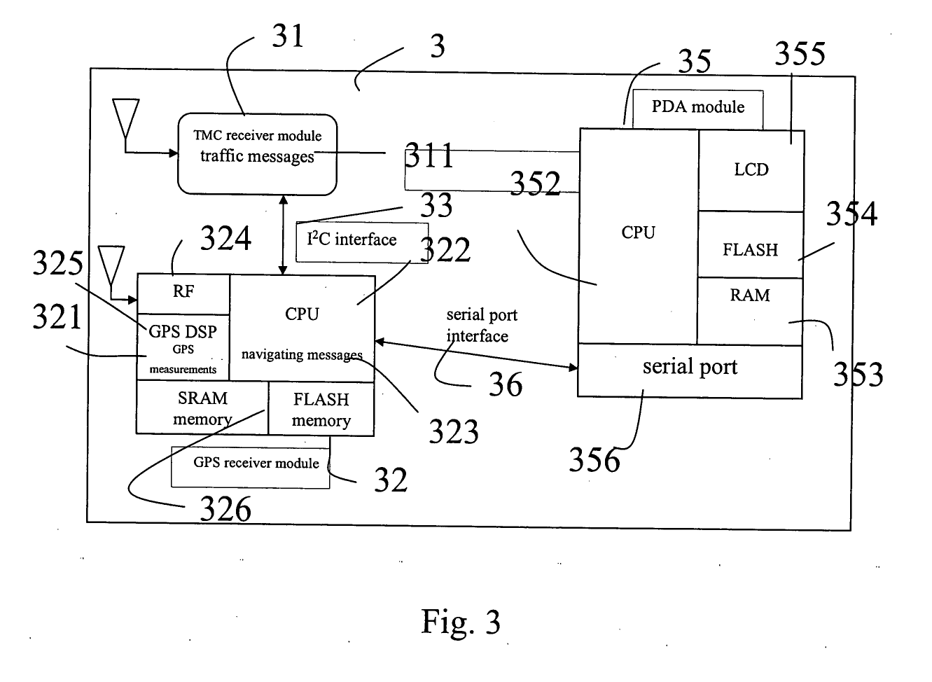

Certainly, the global positioning system (GPS) receiver module and the traffic message channel (TMC) receiver module could be further integrated with a PDA module according to the present invention. Please refer to FIG. 3. It illustrates a block diagram of a second embodiment of a navigating apparatus with GPS and TMC according to the present invention. The portable computer with integrated navigating apparatus includes a traffic message channel (TMC) receiver module 31 for receiving traffic messages 311; a global positioning system (GPS) receiver module 32 for receiving GPS measurements 321 via the GPS receiver module 32, wherein the GPS receiver module 32 further comprises a central processing unit (CPU) 322; a connecting interface 33 connected between the TMC receiver module 31 and the GPS receiver module 32 to transmit the traffic messages 311 from the TMC receiver module 31 to the CPU 322 of the GPS receiver module 32 for integrating the traffic messages 311 and the GPS measurements 321 via the CPU 322 and producing navigating messages 323; a personal digital assistant (PDA) module 35; and a serial port interface 36 connected with the PDA module 35 and the GPS receiver module 32 for transmitting the navigating messages 323 from the GPS receiver module 32 to the PDA module 35, thereby the navigating messages 323 being displayed on the PDA module 35 directly.

In practice, the GPS receiver module 32 also includes a radio Certainly, the GPS receiver module 32 further includes a memory unit 326, wherein the memory unit 326 can be comprised of RAM memory and FLASH memory. Similarly, the connecting interface 33 can be an Inter-IC (I2C) interface or any other serial/parallel transmission interfaces. Furthermore, the PDA module 35 includes a CPU 352, a RAM memory 353, a FLASH memory 354, a LCD unit 355, and a serial port 356.

According to the disclosed structure, the present invention further disclosed a method of integrating navigating-information of a traffic message channel (TMC) receiver module 31 and a global position system (GPS) receiver module 32. The method includes the steps of a) receiving traffic messages 311 via the TMC receiver module 31; b) receiving GPS measurements 321 via the GPS receiver module 32; c) transmitting the traffic messages 311 from the TMC receiver module 31 to the GPS receiver module 32; d) transforming the traffic messages 311 and the GPS measurements 321 into navigating messages 323; and e) transmitting the navigating messages 323 to a remote client 351 for displaying the navigating messages on the remote client 351 directly, wherein the step c) can be executed via the Inter-IC (I2C) interface 33 connected between the TMC receiver module 31 and the GPS receiver module 32 to transmit the traffic messages 311 from the TMC receiver module 31 to the GPS receiver module 32. Certainly, the GPS receiver module 32 could include a CPU 322 as shown above.

In practice, the step e) can be a bluetooth transmission, as the embodiment shown in FIG. 2. Certainly, the step e) also could be executed by means of serial-port-interface transmission, as the embodiment shown in FIG. 3. According to the method introduced by the present invention, the CPU 322 of the GPS receiver module 32 could effectively integrate the traffic message 311 and the GPS measurements 321 and produce navigating messages 323 in step d), wherein the navigating messages 323 can be utilized directly by the navigating program in a PDA without decoding.

In conclusion, the present invention provides a navigating apparatus with a GPS receiver module and a TMC receiver module, which is capable of effectively integrating signals of GPS and TMC via a simplified structure, fewer operations and producing steps. Meanwhile the traffic messages and the GPS measurements are effectively integrated into navigating messages thereby being utilized directly by the navigating program in a PDA without decoding, and the prior art fails to disclose that. Accordingly, the present invention possesses many outstanding characteristics, and effectively improves upon the drawbacks associated with the prior art.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An integrated navigating apparatus comprising:
a traffic message channel (TMC) receiver module for receiving traffic messages;
a global positioning system (GPS) receiver module for receiving GPS measurements via the GPS receiver module, wherein said GPS receiver module further comprises a central processing unit (CPU);
a connecting interface connected between said TMC receiver module and said GPS receiver module to transmit said traffic messages from said TMC receiver module to said CPU of said GPS receiver module for integrating said traffic messages and said GPS measurements via said CPU and producing navigating messages; and
a local wireless transmitting module connected with said GPS receiver module for transmitting said navigating messages to a remote wireless client, thereby said navigating messages being displayed on said remote wireless client directly.

2. The integrated navigating apparatus according to claim 1, wherein said GPS receiver module further comprises a radio frequency (RF) receiving unit and a digital signal processor (DSP) unit.

3. The integrated navigating apparatus according to claim 1, wherein said GPS receiver module further comprises a memory unit.

4. The integrated navigating apparatus according to claim 3, wherein said memory unit is one of RAM memory and FLASH memory.

5. The integrated navigating apparatus according to claim 1, wherein said connecting interface is an Inter-IC (12C) interface.

6. The integrated navigating apparatus according to claim 1, wherein said remote wireless client is a Bluetooth transmitting module of a personal digital assistant (PDA).

7. The integrated navigating apparatus according to claim 1 further comprising a serial port interface connected with said local wireless transmitting module and said GPS receiver module.

8. A portable computer with integrated navigating apparatus comprising:
a traffic message channel (TMC) receiver module for receiving traffic messages;
a global positioning system (GPS) receiver module for receiving GPS measurements via the GPS receiver module, wherein said GPS receiver module further comprises a central processing unit (CPU);
a connecting interface connected between said TMC receiver module and said GPS receiver module to transmit said traffic messages from said TMC receiver module to said CPU of said GPS receiver module for integrating said traffic messages and said GPS measurements via said CPU and producing navigating messages;
a personal digital assistant (PDA) module; and
a serial port interface connected with said PDA module and said GPS receiver module for transmitting said navigating messages from said GPS receiver module to said PDA module, thereby said navigating messages being displayed on said PDA module directly.

9. The portable computer with integrated navigating apparatus according to claim 8, wherein said GPS receiver module further comprises a radio frequency (RF) receiving unit and a digital signal processor (DSP) unit.

10. The portable computer with integrated navigating apparatus according to claim 8, wherein said GPS receiver module further comprises a memory unit.

11. The portable computer with integrated navigating apparatus according to claim 10, wherein said memory unit is one of RAM memory and FLASH memory.

12. The portable computer with integrated navigating apparatus according to claim 8, wherein said connecting interface is an Inter-IC (I2C) interface.

13. The portable computer with integrated navigating apparatus according to claim 8, wherein said PDA module further comprises a CPU, a RAM memory, a FLASH memory, a LCD unit, and a serial port.

14. A method of integrating navigating-information of a traffic message channel (TMC) receiver module and a global position system (GPS) receiver module comprising the steps of:
a) receiving traffic messages via said TMC receiver module;
b) receiving GPS measurements via said GPS receiver module;
c) transmitting said traffic messages from said TMC receiver module to said GPS receiver module;
d) transforming said traffic messages and said GPS measurements into navigating messages; and
e) transmitting said navigating messages to a remote client for displaying said navigating messages on said remote client directly.

15. The method of integrating navigating-information according to claim 14, wherein said step c) is executed via an Inter-IC (I2C) interface connected between said TMC receiver module and said GPS receiver module to transmit said traffic messages from said TMC receiver module to said GPS receiver module.

16. The method of integrating navigating-information according to claim 14, wherein said GPS receiver module further comprises a CPU.

17. The method of integrating navigating-information according to claim 14, wherein said step e) is a bluetooth transmission.

18. The method of integrating navigating-information according to claim 14, wherein said step e) is executed by means of serial-port-interface transmission.

19. The method of integrating navigating-information according to claim 14, wherein said remote client is a personal digital assistant (PDA) module.
